(19) United States
(12) Patent Application Publication
(10) Pub. No.: US 2007/0235524 A1
(43) Pub. Date: Oct. 11, 2007

(54) DATA CARD MANAGEMENT SYSTEM

(76) Inventor: Michael E. Little, Cedar Park, TX (US)

Correspondence Address: LAW OFFICE OF STEVEN B. LEAVITT, L.L.P., P.O. BOX 537, ROWLETT, TX, 75030-0537, US

(21) Appl. No.: 11/279,294

(22) Filed: Apr. 11, 2006

(51) Int. Cl. G06K 5/00

(52) U.S. Cl. 235/380

(57) ABSTRACT

A data card management system that consolidates and manages use of a plurality of single-function data cards using one, portable multifunction data card. The cardholder accesses the secure, internet-based system using a computer with access to the Internet. Once accessed, the user completes: (1) account registration; (2) card data collection from the user's single-function data cards; (3) profile creation defining how collected card data will be used; and (4) multifunction card data card activation choosing personalized features, which includes profiles, to be saved on the card subsequently issued to the user. Several multifunction data cards can be issued to one user account with access to the account's card data being dependent upon profiles stored on that card. The system also has the ability to assists the user in typical personal tasks, such as budgeting using a budget profile, and generating reports tracking the use of the multifunction data card.

### BACKGROUND OF THE INVENTION

1. Technical Field

The present invention relates generally to multifunction data cards. More particularly, the invention relates to a secure internet-based data card management system to obtain, tailor the functionality of, and manage information stored on a portable, multifunction data card.

2. Description of Related Art

Many people carry data cards, usually multiple data cards, for financial transactions, identification, security and access, health information, and the like. Examples of data cards include credit cards, debit cards, driver's licenses, social security cards, health and car insurance cards, and security badges for building access. The use of these cards appears to permeate through society and often the number of data cards one carries can become unwieldy thereby causing some cards to be left out of an already bulging wallet or pocketbook and inconveniently unavailable to the cardholder when needed. Also, carrying multiple data cards provides opportunities for the cardholder to be adversely affected if any of these cards are lost or stolen.

In addition to the cardholder's limited ability to ensure the physical security of their data cards, effective use and management of the information stored on these cards appears to be equally limited. For example, a cardholder may plan to spend a particular amount for certain items on designated cards in order to collect reward points, try and stay on a budget, or to limit the balance on relatively high interest credit cards. However, the cardholder is not likely to closely monitor how much is spent on which items and most card issuers do not provide this kind of budgeting function.

Also, it is not an unusual occurrence for the cardholder to be a parent with a child and for the parent to provide their child with a credit or debit card and verbal instructions on how much the child is allowed to spend. Often, despite the verbal instructions, the imposed limits are not adhered to and the parent has no or very few means to ensure the limits are not surpassed.

Because data cards are a convenient way to store information, the use of data cards will likely increase and the many cards generated will make managing a cardholder's personal information embodied in these cards more and more difficult.

Currently, there are a variety of multi-application, or multifunction, data cards. Generally, these cards are intended to store information from a variety of cards on only one, portable data card. The stored information can include a variety of data such as financial relationships, identification, and security and access control data. The majority of these cards store their data on a magnetic stripe placed on a portion of the card. Some cards that require more data to be stored on them, such as security and access control cards, may incorporate an integrated circuit (IC) chip to store this information. The amount of information stored does not appear to have a limit outside of the inherent memory constraints of the magnetic stripe or IC chip. Protection of this stored information is achieved through various means such as the use of a personal identification number (PIN), random code generation, and biometric information encoded on the card for “real time” comparison. It appears that many of the issuers, and managers, of these multifunction data cards are “third-parties” (i.e., parties that did not provide the single-function card to the cardholder).

However, current multifunction data cards are not associated with an internet-based system that allows the cardholder to obtain, tailor the functionality of, and easily manage the information embodied on their multifunction data card.

### SUMMARY OF THE INVENTION

The present invention provides an internet-based data card management system for the consolidation and management of the information stored on multiple single-function data cards using one, portable multifunction data card. The present invention patent also includes an online management system that leverages smart cards to simplify the management of data access cards including but not limited to financial management cards such as credit cards, identification cards such as drivers license, social security cards, medical ID cards, and data access cards such as computer and building access cards.

In the preferred embodiment, the cardholder accesses the secure, internet-based system using a computer with access to the Internet. Once accessed, the system allows the cardholder, or user, to register an account on the system. During the account registration process, the system prompts the user to select a service package and enter account information such as contact and billing information. A service package consists of a service and a corresponding service level at which the service is to be offered. Examples of services available are financial services, identity management services, and access control services.

Financial services allow the user to manage information from financial data cards such as credit cards and debit cards. Management services allow the user to manage publicly-issued identification, such as driver's licenses and social security cards. Access control services allow the user to consolidate information from single-function data cards such as security badges and building card keys. Each service contains different levels and the levels are tailored to the public's or user's needs. For example, one level may allow for only one user while a second level allows for 1-5 users to use the service and a third level allows for 5+ users to use the service. In another example, one level may limit the number of hours a user can have access to the system while a second level provides unlimited hours. In yet another example, one level may offer minimal consumer theft protection while a second level offers greater theft protection.

After the account registration process is complete and a user account is created, the system begins the card data collection process and prompts the user to enter card data into the system that corresponds to the service or services selected by the user. In one embodiment, the system accesses any online systems that can provide data relative to a user's account. For example, many credit card companies allow their users to access card balances, current and past charges, and other features via the Internet.

Next, the system begins the profile creation process and allows the user to create profiles that define how the data collected during the account registration process will be used. For example, if the user selected the financial services, then a profile may be a budgeting profile or amount per card allocation profile. The system creates a profile or list of profiles for each service that was selected by the user and displays the profile or profiles to the user. The system determines what profile the user selects and if necessary, prompts the user to enter any information necessary to complete the profile creation process.

After the profile creation process, the system begins the multifunction data card activation process. During this process, the system allows the user to select personalized features, such as the name on the card, color and/or graphics on the card, profiles, and security features, for the multifunction data card. The system then issues the user a portable, multifunction data card with the user's contact information and selected features stored on it. The information and features stored on the card are profile specific and only the information relative to the selected profile are be stored on the card.

The primary advantage of the data card management system is that it not only gathers data from multiple single-function data cards onto one, multifunction data card, but also provides the user with a simple, accessible tool with which to manage the data. Other advantages of this system are that it allows multiple cards to be issued to one user account, assists in typical personal tasks such as budgeting, and generates reports tracking the use of an account's multifunction data cards.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart illustrating an overview of the preferred embodiment of the data card management system;

FIG. 2 is a flow chart illustrating the account registration process of the data card management system shown in FIG. 1;

FIG. 3 is a flow chart illustrating the card data collection process of the data card management system shown in FIG. 1;

FIG. 4 is a flow chart illustrating the profile creation process of the data card management system shown in FIG. 1;

FIG. 5 is a flow chart illustrating the multifunction data card activation process of the data card management system shown in FIG. 1; and

FIG. 6 is a flow chart illustrating the use of the profile creation process shown in FIG. 4 to create a budget profile for a user account registered to receive financial service.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

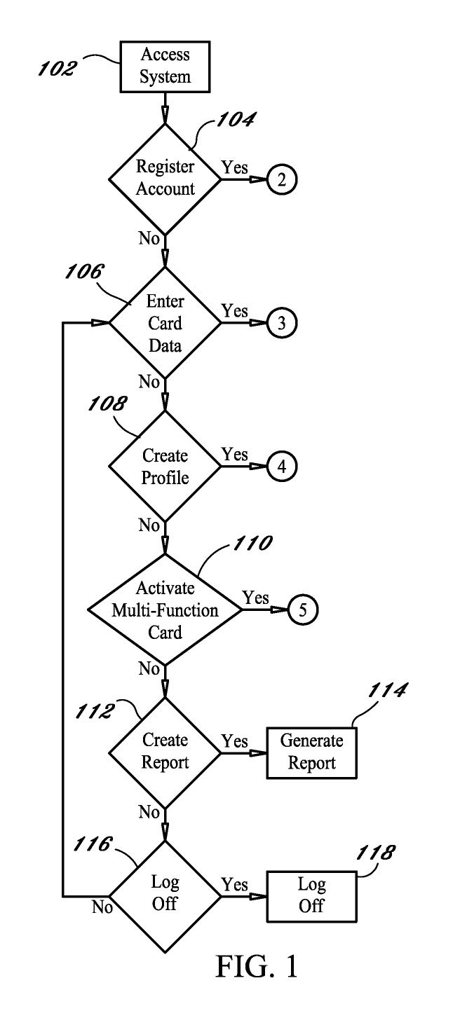

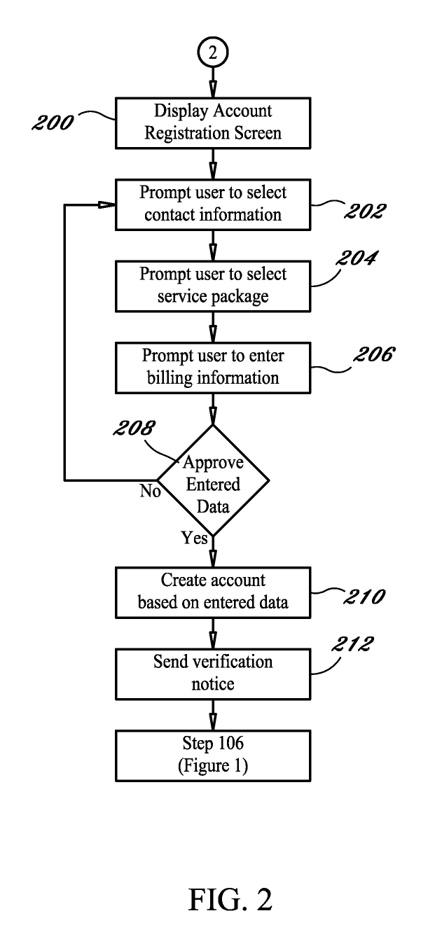

The present invention is a secure, internet-based data card management system. The first step, show in FIG. 1, a user logs onto or the system is accessed, Step 102. Then the system determines if the user wants to register an account, Step 104. If the system determines the user wants to register an account, then the system displays the account registration screen, Step 200 (FIG. 2).

### Account Registration Process

From the displayed account registration screen, the system begins the account registration process and prompts the user to enter user contact information, Step 202. User contact information includes but is not limited to such information as name, physical address, telephone number, and e-mail address. Then, the system determines what service package or packages the user wants, Step 204. A service package consists of a service and a corresponding service level of which the service is to be offered. A variety of services may be offered including but not limited to financial services, identity management services, and access control services.

Financial services allow a user to manage information from financial data cards such as credit cards and debit cards. Management services allow the user to manage publicly-issued identification, such as driver's licenses and social security cards. Access control services allow the user to consolidate information from single-function data cards such as security badges and building card keys. Each service contains different levels and the levels are tailored to the public's or user's needs. For example, one level may allow for only one user while a second level allows for 1-15 users of the service and a third level allows for 15+ users of the service. In another example, one level may limit the number of cards that can be issued at one time or during a month while a second level provides unlimited issuance of cards. In yet another example, one level may offer minimal consumer warranty protection while a second level offers greater consumer warranty protection.

After the system determines what service or services the user wants, the system prompts the user to enter billing information, Step 206. In one embodiment the cost of the system is based on the number of services selected and the level of each service. For example, purchasing two services for 5 people would be more expensive than purchasing one level of service for one user.

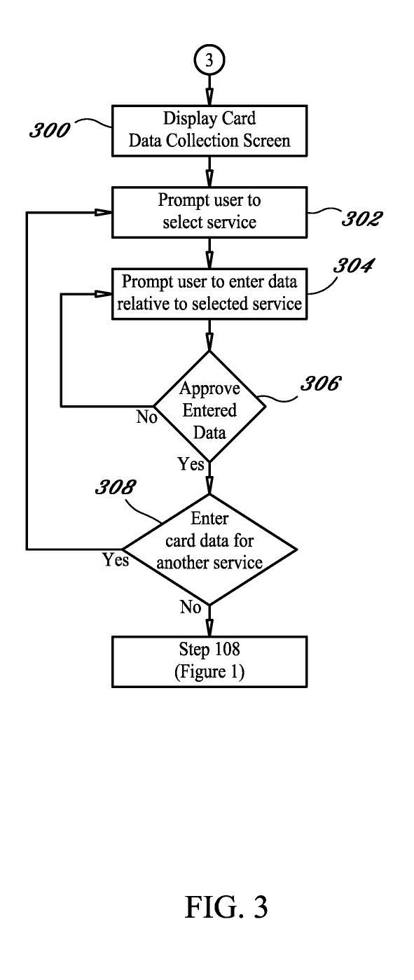

After the user enters billing information into the system, Step 206, the system allows the user to review entered contact information, the service package or packages selected along with the corresponding level, and the billing information and determines if the user approves the entered or selected data, Step 208. If the user does not approve the entered or selected data, then the system return to step 202, allows the user to re-enter or amend the entered data, and continues to Steps 204 and 206. If the system determines that the user approves the entered or selected data, then the system creates an account based on the data, Step 210. After the system creates an account, the system sends a verification notice to the user, Step 212. Preferably, the verification is an e-mail send to the e-mail address listed in the contact information. After the system sends a verification notice to the user, the system determines if the user wants to enter card data, Step 106 (FIG. 1). Going back to Step 104, if the system determines the user does not want to register an account, then the system determines if the user wants to enter card data, Step 106. If the system determines the user wants to enter card data, then the system displays the card data collection screen, Step 300 (FIG. 3).

### Card Data Collection Process

From the card data collection screen, the system begins the card data collection process and determines for what specific service the user would like to enter card data, Step 302. If the user has selected only one service, then this step may be skipped. If the user has selected multiple services, then the system may display each service and allow the user to select for what service they would like to enter card data. Because each service selected by the user typically requires different data and some services may require a relatively small amount of data while others may require a relatively large amount of data, the card data collection process is more efficient and less time consuming if the system only requires the user to enter in data relative to the service the user has selected.

After the system determines what service the user would like to enter card data, the system prompts the user to enter data relative to the selected service, Step 304. For example, data relative to a selected service may include, but is not limited to account number, identification number, current balance, and the expiration date from each single-function data card applicable to the selected service.

After the user has entered the card data, the system determines if the user approves the entered card data, Step 306. If the system determines the user does not approve the entered or selected data, then the system returns to Step 304, and allows the user to re-enter or amend the entered data. If the system determines that the user approves the entered or selected data, then the system determines if the user wants to enter card data for another service, Step 308.

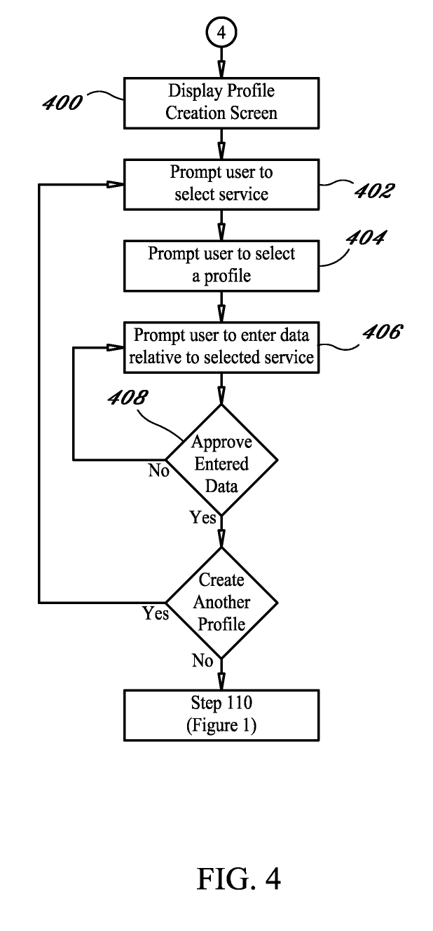

If the system determines the user wants to enter card data for another service, then the system determines for what service the user would like to enter card data, Step 302. If the system determines the user does not want to enter card data, then the system the system determines if the user wants to create a profile, Step 108 (FIG. 1). Going back to Step 106, if the system determines the user does not want to enter card data, then the system determines if the user wants to create a profile, Step 108. If the system determines the user wants to create a profile, then the system displays the profile creation screen, Step 400 (FIG. 4).

### Profile Creation Process

From the card data collection screen, the system begins the profile creation process. The profile creation process defines how card data gathered during the above collection process is to be accessed or used the user and third parties such as a spouse or child. The profile creation process begins with the system determining for what specific service the user would like to create a profile, Step 402. If the user has selected only one service, then this step may be skipped. If the user has selected multiple services, then the system may display each service and allow the user to select for what service they would like to create a profile. Because each service selected by the user typically requires different profiles and some profiles may require a relatively small amount of set up time while others may require a relatively large amount of set up time, the profile creation process is more efficient and less time consuming if the system only requires the user to create profiles relative to the service the user has selected.

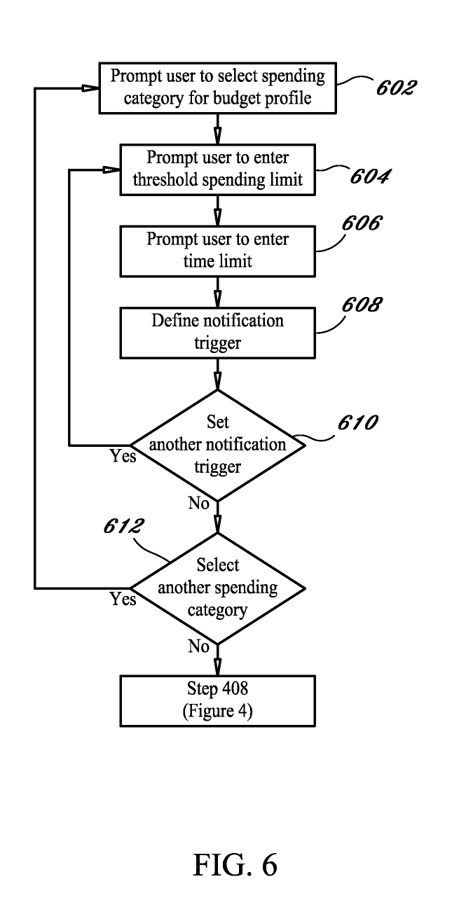

After the system determines what specific service the user would like to create a profile, Step 402, the system displays a list of profiles types available for that service and determines what profile the user would like to use, Step 404. An example of a list of profiles are spending limits on certain cards, or is the service is an access control services, access to certain areas at only certain times. After they system determines what profile the user would like to use, the system prompts the user to enter information the system needs in order to implement the selected profile, Step 406. For example, if the profile is for spending limits, then the system prompts the user to enter the limit amount. If the profile is for access control, then the system prompts the user to enter the areas to be accessed and the times the areas can be accessed. A more detailed example is illustrated in FIG. 6 and will be described in detail below. It should be noted that, only card data or information associated with the selected profile is stored on the multifunction data card when the card is issued.

After the user has entered the information the system needs in order to implement the selected profile, the system determines if the user approves the entered information, Step 408. If the system determines the user does not approve the entered information, then the system returns to Step 406, and allows the user to re-enter or amend the entered data. If the system determines that the user approves the entered information, then the system determines if the user wants to create another profile, Step 410.

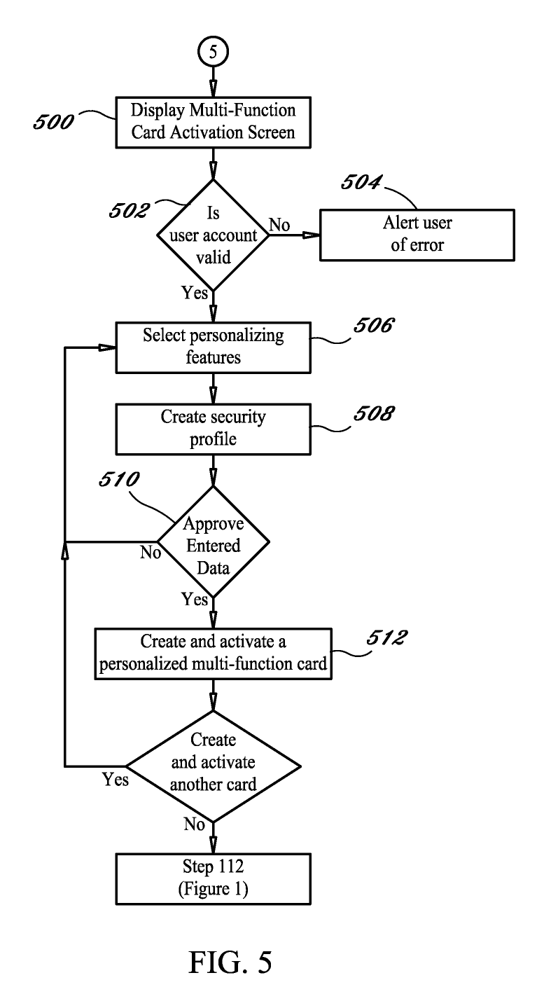

If the system determines the user wants to enter card data for another service, then the system determines for what service the user would like to enter card data, Step 402. If the system determines the user does not want to enter card data, then the system the system determines if the user wants to activate a multifunction card, Step 110 (FIG. 1). Going back to Step 108, if the system determines the user does not want to create a profile, then the system determines if the user wants to activate a multifunction card, Step 110. If the system determines the user wants to activate a multifunction card, then the system displays the multifunction card activation screen, Step 500 (FIG. 5).

### Multifunction Data Card Activation Process

From the multifunction card activation screen, the system begins the multifunction card activation process and determines if the status of the current user's account is valid, Step 502. The validation includes, but is not limited to, ensuring that all account information has been properly completed, at least one service package has been selected, and the service level selected by the user allows for the activation of a multifunction data card. For example, if a user has selected that only two multifunction data cards can be activated at a time, the system would not all a third multifunction data card to activated.

If they system determines that the user account status is not validated, then the system alerts the user of errors identified by system and may give the user an opportunity to remedy the errors, Step 504. The alert may be in the form of, but not limited to, an e-mail, page, and/or text message to a cell phone and may prevent unauthorized users from accessing the system and creating unauthorized multifunction data cards.

If the system determines that the user account status is valid, then the system allows the user to select personalizing features to add to the multifunction data card to be issued, Step 506. Examples of personalized features include but are not limited to the name displayed on the card, color and/or graphics on the card, profiles, and security features for the multifunction data card. The personalized features may be provided by the system or uploaded to the system. If the user wants a profile that is not available or has not been created yet, then the system may offer the user the ability to create a profile and start the profile creation process shown in FIG. 4. In addition to personalized features, the system may allow the user to input related to security measures for the prevention of fraudulent use of the multifunction data card, Step 508. The input may include a pin number or a biometric marker such as a user fingerprint. The input would be integrated as a personalized feature of multifunction data card.

After the user has entered the information the system needs in order to personalize the multifunction data card, the system determines if the user approves the entered information, Step 510. If the system determines the user does not approve the entered information, then the system returns to step 506, and allows the user to re-enter or amend the entered data. If the system determines that the user approves the entered information, then the system stores all the necessary information on a data card and creates and activates a personalized, multifunction card for the user, Step 512. Only card data or information associated with the selected profile for the multifunction data card is stored on the card.

After the personalized, multifunction data card is created and activated, the system determines if the use wants to create and activate another card, Step 514. If the user wants to create and activate another card, then the system returns to Step 506 and allows the user to select personalizing features to add to the multifunction data card to be issued. If the user does not want to create and activate another card, then the system determines if the user wants to create a report, Step 112 (FIG. 1).

If the system determines the user wants to create a report, then the system determines what report to create and displays the report to the user, Step 114. The report would detail the information on each card and track the use of each multifunction data card and associated data. For example, a report for financial services may provide a detailed list of spending habits for specific categories, a report for management services may provide a detailed list of how many times, when and where the information relating to a driver's license or social security card was accessed, and a report for access control services may provide details about when and what and how long areas were accessed by the user.

If the system determines the user does not want to create a report, then the system determines if the user wants to log off, Step 116 (FIG. 1). If the system determines the user does not want to log off, then the system determines if the user wants to enter card data, Step 106. If the system determines the user wants to log off, then the system logs the user off, Step 118.

### Budget Profile Creation Process

In one embodiment, financial services include the ability to create a budget profile. To create a budge profile, the user would have selected financial services at Step 204 (FIG. 2), entered card data relative to financial services at Step 302 (FIG. 3), and selected the budget profile at Step 402 (FIG. 4). FIG. 6 shows a detailed example where the system prompts the user to enter information the system needs in order to implement the of the budget profile creation process, Step 406.

First the system prompts the user to select a spending category for the budget profile, Step 602. Examples of spending categories include but are not limited to gasoline, groceries, entertainment, or restaurants. The categories may be displayed by the system or the user may be allowed to enter their own category.

After the user selects a spending category, the system prompts the user to enter a threshold spending limit for the selected category, Step 604, and a time period over which the threshold spending limit to be applied, Step 606. For example, if the category is gasoline then the threshold spending limit may be $20.00 per week or the threshold spending limit may be $100 per month.

After the user has entered the threshold spending limit and time period the limit applies, the system prompts the user to define a notification trigger for the selected spending category, Step 608. In another embodiment, the notification trigger can be applied to all spending categories as a group or individually as described herein. The notification trigger is an alert or alarm that the system uses to notify the user when a specific dollar amount or percentage of a spending category is spent. Examples of notification triggers include but are not limited to an e-mail, page, phone call, or text message. When activated, the system sends the alert to the user via the communication method selected in Step 608. For example, if the category is gasoline and the threshold spending limit and time period is $20 per week, then a notification trigger may be set at $15 and an e-mail may be sent to the user when in one week $15 or more is charged on the multifunction data card.

After the user defines a notification trigger for a spending category, the system determines if the user wants to set another notification trigger for the spending category, Step 610. If the user wants to set another notification trigger, then the system returns to Step 604. If the user does not want to set another notification trigger, then the system determines if the user wants to select another spending category, Step 612.

If the system determines the user wants to select another spending category, then the returns to Step 602 and prompts the user to select a spending category for the budget profile. If the system determines the user does not want to select another spending category, then the system determines if the user approves the entered information, Step 408 (FIG. 4).

A useful aspect of the above budget profile is that, if the user creates a multifunction data card for a child, the user can control the ability for that child to spend a certain amount of money for certain amount of categories. Triggers would be sent to the user to track the child's spending habits and once a certain limit has been reached for a category, the card be disabled with respect to purchases from that category. The notification triggers could be used to alert the child at certain amount then to alert both the user and the child at a higher amount.

Also, a notification trigger could be set to notify the user when the child attempts to use the multifunction data card for items in an undefined spending category or in a location outside of or in a defined area. For example, the system could limit the use of the multifunction data card to a zip code or group of zip codes to ensure the child stays within a certain area or the system could block the cards use at all bars, clubs, and dance halls.

Budget profile equips user with a “real time” budgeting tool due to a user's ability to clearly and easily define spending limits and receive an alert when the defined spending limits are reached. Conventional budgeting methods do not alert the user that they are nearing or have exceeded their spending limit until the user reconciles finances themselves.

Preferably, for the multifunction data card is of a size and shape where it can be easily transported in a wallet or pocket book, used with conventional card readers, and has the ability to store a variety of data types from diverse card data sources. In addition the multifunction data card should be composed of a material, for example plastic, that can withstand continued and prolonged use.

Preferred forms of the invention have been shown in the drawings and described above, but variations in the preferred forms will be apparent to those skilled in the art. The preceding description is for illustration purposes only, and the invention should not be construed as limited to the specific form shown and described. The scope of the invention should be limited only by the language of the following claims.

What is claimed is:

1. A data card management system for consolidating and managing the use of a plurality of single-function data cards, the system comprising:
a means for the user to accessing the system;
an account registration process;
a card data collection process;
a profile creation process;
a multifunction data card activation process; and
a multifunction data card.

2. The system in claim 1 wherein the means for user to access the system comprises a computer with Internet access.

3. The system in claim 1 wherein the account registration process comprises:
a means for the user to enter contact information;
a means for the user to select a service package;
a means of the user to enter billing information; and
a verification provided to the user upon creation of a user account.

4. The system in claim 3 wherein the service package comprises:
a service; and
a service level.

5. The system in claim 4 wherein said service comprises:
a financial service;
an identity management service; and
an access control service.

6. The system in claim 1 wherein the card data collection process comprises:
a means for the user to select the service to collect card data for; and
a means for the user to enter the card data from each single-function data card applicable to the service.

7. The system in claim 1 wherein the profile creation process comprises:
a means for the user to select the service to create a profile for;
a means for the user to select from profile types available for the selected service; and
a means for the user to enter information required to complete the selected profile.

8. The system in claim 7 wherein the information includes the card data selected by the user for management by the profile.

9. The system in claim 1 wherein the multifunction data card activation process comprises:
a validation of the user account status;
a means for the user to select personalized features for the multifunction data card;
a means for the system to store selected the personalized features on the multifunction data card; and
a means for the system to issue the multifunction data card to the user.

10. The system in claim 9 wherein the validation comprises:
a means for the system to discover errors in the user account; and
a means for the user to remedy the errors.

11. The system in claim 9 wherein the personalized features include the profiles created by the user.

12. The system in claim 1 wherein the multifunction data card further comprises:
a size and shape that it can be easily carried by the user in a wallet or purse;
a composition that can withstand continued and prolonged use by the user; and
a means for storing a variety of data types.

13. The system of claim 12 wherein the data types comprises:
a copy of the user contact information; and
the personalized features selected by the user.

14. The system in claim 1, further comprising:
a means for the user to review, edit and approve of information the user entered into or selected from the system; and
a means for the system to generate reports tracking use of the multifunction data card upon request of the user.

15. A method of consolidating and managing the use of a plurality of single-function data cards, the method comprising the steps of:
accessing a system and;
registering an account on the system;
entering in card data into the system;
creating a profile on the system; and
activating a multifunction data card created by the system.

16. The method of claim 15 wherein the system comprises a computer with Internet access.

17. The method of claim 15 wherein the step of registering an account comprises:
entering contact information;
selecting a service package; and
entering billing information.

18. The method of claim 15 wherein the step of creating a profile on the system comprises:
selecting a service to create a profile for;
selecting from profile types available for the selected service; and
entering information required to complete the selected profile.

19. The method of claim 18 wherein the selected service is a financial service, an identity management service, or an access control service.

20. The method in claim 15 wherein the multifunction data card activation process comprises:
validating user account status;
selecting personalized features for the multifunction data card;
storing the selected personalized features on the multifunction data card; and
issuing a multifunction data card to the user by the system.
